(19) United States
(12) Patent Application Publication
(10) Pub. No.: US 2007/0068135 A1
(43) Pub. Date: Mar. 29, 2007

(54) Engine

(76) Inventor: Bernard Gill, Sahburn By The Sea (GB)

Correspondence Address: Zilka-Kotab, PC, P.O. BOX 721120, SAN JOSE, CA, 95172-1120, US

(21) Appl. No.: 11/418,844

(22) Filed: May 5, 2006

Related U.S. Application Data
(63) Continuation-in-part of application No. 10/470,361, filed on Apr. 1, 2004, now abandoned.

(30) Foreign Application Priority Data
Jan. 26, 2001 (GB) 0102028.8

(51) Int. Cl. F02C 3/045

(52) U.S. Cl. 60/39.43; 60/805

(57) ABSTRACT

Engine 30 has a compression fan 36 coaxially mounted with reaction member 38. Casing 32 extends around reaction member 38 to form volute 52 and extends to turbine wheel 54 which is connected to compression fan 36 via axle 40. Reaction member 38 comprises vanes 60, flame grid 62 and supporting members in the form of side casings 64. A mixture of fuel and air enters engine 30 via inlets 34. The mixture is drawn into compression fan 36 which causes an increase in the pressure of the mixture. From the compression fan 36 the mixture is directed towards the reaction member 38. Because the compression fan 36 is rotating in a first sense and the reaction member 38 is rotating in a second sense, the velocity of the fuel and air mixture entering the reaction member 38, relative to the reaction member 38, is approximately the sum of the external rim velocity of the compression fan 36 and the internal rim velocity of the reaction member 36. The mixture is burnt within the reaction member 38 and the vectored gases cause the rotation of the reaction member 38 in the second sense.

### RELATED APPLICATION(S)

The present application is a continuation-in-part of a patent application filed Apr. 1,2004 under Ser. No. 10/470,361 and attorney docket number UDL1P006 and naming the same inventors, and claims priority from a United Kingdom patent filed Jan. 26, 2001 under application number 01,020,288, which are incorporated herein by reference in their entirety.

### FIELD OF THE INVENTION

The present invention relates to engines and relates particularly, but not exclusively, to engines used in the generation of electricity.

### BACKGROUND OF THE INVENTION

An example of an engine used in the generation of electricity is shown in FIG. 1. The engine, known as a gas turbine engine, comprises a compressor 10 which compresses air drawn in through an air inlet 11. The compressed air is heated in a heat exchanger 12, taking advantage of the hot exhaust gases of the engine. The heated compressed air is mixed with fuel from a fuel inlet 13 and is burnt in a combustion chamber 14 where the volume of gas significantly increases causing the velocity at which the gas is moving to also significantly increase. The fast moving gas is directed through a turbine 15 which is caused to rotate and the excess hot gas is exhausted via heat exchanger 12. The rotation of turbine 15 drives a shaft 16 which is connected to compressor 10 and provides the power for compression of the air within compressor 10. The shaft is also connected to a generator 17 which generates electricity. The above described gas turbine engine suffers from the disadvantage that such turbine engines are most efficient and effective on a large scale and do not adapt well to being scaled down to small applications such as generating electricity for single domestic premises or recharging car batteries in a hybrid car.

### SUMMARY

Preferred embodiments of the present invention seek to overcome the above described disadvantages of the prior art.

According to an aspect of the present invention there is provided an engine comprising:

a housing having at least one inlet and at least one exhaust outlet;

a compression fan adapted to rotate in a first sense to cause compression of a fuel and air mixture; and

a reaction member mounted substantially coaxially with said compression fan and comprising a plurality of vanes, wherein the reaction member is adapted to receive said compressed fuel and air mixture from said compression fan and in use said fuel and air mixture is burnt between said vanes and gases produced by said burning are vectored to cause said reaction member to rotate in a second sense opposite to said first sense.

By providing a compressor which feeds a fuel and air mixture directly into a reaction member, the advantage is provided that because the compression fan and reaction member are rotating in opposite senses, the relative velocity of the fuel air mixture entering the reaction member is approximately equal to the outer rim velocity of the compression fan added to the reaction member velocity at the same radius. This high entry velocity when diffused within the reaction member results in a higher compression ratio than could be achieved by the compression fan alone. When the air/fuel mixture is burnt, the force of the expanding combustion gases as they escape tangentially from the reaction member act directly upon the reaction member giving efficient conversion of the energy of combustion of the fuel air mix to rotational energy of the reaction member. For example such an engine can be used to generate electricity on a single domestic scale or used to recharge batteries in a hybrid car. Engines which are typically used for such purposes at present include the internal combustion engine, generally of the petrol or diesel type. The above described invention provides the advantage over these types of engine that there is no conversion of the linear motion of pistons in to the rotary motion of a drive shaft with the inherent losses in energy which will occur. Furthermore there is no requirement for a continuously operating ignition timing mechanism or complex water cooling system which also reduces the energy losses of the engine of the present invention.

In a preferred embodiment said fuel and air mixture are further compressed within said reaction member.

By further compressing the fuel and air mixture the advantage is provided that the engine has a higher output per unit size of engine.

In a preferred embodiment said further compression occurs by diffusion of said mixture within said reaction member.

In another preferred embodiment said further compression occurs by ram compression of said mixture within said reaction member.

In a preferred embodiment said compression fan discharges said mixture in a direction substantially tangential to a circle defined by the rotation of vane tips of the vanes of the compression fan.

Because the mixture is discharged from the compression fan substantially tangentially to the fan, the radial component of the velocity of the mixture at that point is minimised. Therefore the mass flow that will pass through the engine can be reduced and the unit can be produced with lower output thereby increasing the number of potential applications.

In another preferred embodiment said fuel and air mixture is received within said reaction member at a velocity relative to the reaction member substantially equal to the sum of the velocities of the compression fan vane tips and the reaction member at substantially the same radius.

In a preferred embodiment the engine further comprises at least one turbine member for driving said compression fan.

In another preferred embodiment, at least one said turbine member is driven by exhaust gases from said reaction member.

In a preferred embodiment, said fuel and air mixture is mixed prior to entry into the engine through the or each inlet.

By mixing the fuel and air prior to entry into the engine the advantage is provided that when the fuel air mixture is burnt in the reaction member it is already thoroughly mixed, thereby burning with maximum efficiency. In particular the mixing occurs prior to the compression fan and as the fuel and air pass through the compression fan, the reaction member (before passing through the flame grid) and through the flame grid itself.

In a preferred embodiment, the cross-sectional area, measured in a circumferential direction, of the space defined by two adjacent vanes, increases as the radial distance from the axis of the reaction member increases, to a maximum substantially half way along the length of said vanes, and then decreases as said radial distance further increases.

By initially increasing and then decreasing the space between each pair of vanes of the reaction member as the distance from the centre of the reaction member increases, the advantage is provided that each section of the reaction member, which is defined by an adjacent pair of vanes, acts in a similar manner to a ram-jet. That is, that as the fuel air mixture is forced at high velocity from the compression fan into the reaction member it is caused to slow down by the increasing volume between two vanes, which in turn increases the pressure of the fuel air mix. At the point when the air fuel mix is slowed down sufficiently to sustain combustion, the fuel air mixture is burnt and the hot expanding combustion gases continue through the passage area between adjacent vanes which vector or direct the combustion gases through a nozzle formed by the now converging adjacent vanes. The direction of the expelled gas is tangential to the reaction member radius thereby causing the tangential jet reaction which rotates the reaction member in the second sense.

In a preferred embodiment said reaction member further comprises a flame grid.

By providing the reaction member with a flame grid the advantage is provided that the grid acts as a bluff body, which causes the velocity of the fuel air mix immediately behind the flame grid to be less than the flame speed relative to the flame grid. As a result, the combustion of the fuel air mix can be controlled at the flame grid.

In a preferred embodiment the flame grid is located at a position along the vanes where the cross-sectional area defined by adjacent vanes, is at its greatest.

By providing the flame grid at the point of greatest cross-sectional area between the vanes, i.e. approximately half way along the length of the vanes, the advantage is provided that the fuel air mix is burnt at the point of slowest gas speed and as a result highest pressure. The decrease in speed and increase in gas pressure results from the increase in cross-sectional area between the vanes.

In a preferred embodiment said vanes are adapted to reduce a cross-sectional area, measured in a circumferential direction, of the space defined by two adjacent vanes, decreases as the radial distance from the axis of the reaction member increases, to a minimum cross-sectional area, thereby substantially defining the flame front, before increasing.

In a preferred embodiment the reaction member further comprises at least one outer supporting member which supports said vanes along at least some of their length.

By providing at least one supporting member for the vanes the advantage is provided that the tendency for the vanes to flex or vibrate is reduced or eliminated.

In a preferred embodiment said reaction member comprises two said outer supporting members attached to said vanes along opposing edges of said vanes.

In another preferred embodiment said vanes are supported substantially along their whole length.

By providing supporting members along the entire length of both sides of the vanes the advantage is provided that the reaction member becomes enclosed and as a result a maximum reaction force from the combustion of the fuel air mix is applied to the reaction member.

In a preferred embodiment said outer supporting members extend to at least partially cover the compression fan.

By extending the outer supporting member to shroud the compression fan more efficient transfer of fuel and air mixture is provided between the compression fan and the reaction member.

In a preferred embodiment said vanes at their smallest radial distance from the axis of the reaction member are at an angle substantially tangential to the outer radius of the compression fan.

By starting the vanes at approximately a tangent to the compression fan the advantage is provided that the fuel air mixture exiting the compression fan enters the reaction member with least resistance from the vanes.

In a preferred embodiment, said housing has at least one further inlet, adapted to allow a flow of cooling air to be entrained between said housing and said reaction member.

In another preferred embodiment, said reaction member has further vanes extending outside of the supporting members of the reaction member, and adapted to provide the flow of cooling air.

In a preferred embodiment, said further vanes are adapted to provide said flow of air at a pressure substantially equivalent to a pressure of combustion products of the burning of the fuel and air mixture immediately adjacent a maximum radius of said reaction member.

According to another aspect of the present invention there is provided an engine comprising:

a housing having at least one inlet and at least one outlet;

a compression fan adapted to rotate in a first sense to cause compression of at least one of at least one oxidising fluid and a mixture of at least one oxidising fluid and at least one fuel; and

a reaction member mounted substantially coaxially with said compression fan and comprising a single combustion zone, wherein the reaction member is adapted to receive the or each compressed oxidising fluid or mixture from said compression fan and the or each mixture or the or each oxidising fluid mixed with at least one fuel is burnt within said combustion zone and gases produced by said burning are directed to cause said reaction member to rotate in a second sense opposite to said first sense.

By using a single combustion zone in an engine of the type defined above, the advantage is provided that all of the surfaces of the reaction member which come into contact with combusted, and therefore very hot, gases have external surfaces to which cooling can be easily applied. Furthermore, a single combustion zone can be created in the form of a hollow disc by partially welding along the edges of two substantially circular sheets of metal. This is significantly easier than the process of forming the reaction member of the prior art. In particular, because the vanes have been removed, the reaction member can be formed from significantly fewer components, which can be easily constructed and components which can be easily cooled. The decrease in the number of components also reduces the weight of the reaction member which in turn reduces its inertia.

The reaction member may further comprise a plurality of nozzles which direct the gases produced by said burning so as to cause said reaction member to rotate.

The reaction member may further comprise a pair of side walls having a substantially saw toothed outer edge in which first sections of said edges are connected together and second sections of said edges form said nozzles.

By forming a reaction member with nozzles which result from the joining together of edges of a pair of saw tooth shaped discs, the advantage is provided that the reaction member can be formed from simply welding two sheets of a suitable material along alternate edges of the saw tooth so as to form roughly triangular nozzle shapes. This results in the same directing of combusted gases out of the reaction member as seen in the prior art forcing them in a direction which is substantially tangential to a radius described by the rotating nozzles. As a result, the simplified device of the present invention is able to produce approximately the same output as the device of the prior art.

In a preferred embodiment the nozzles are formed by attaching nozzle shapers to said second sections of said edges.

By using nozzle shapers to determine the exact dimensions of the output of the nozzles, the advantage is provided that the ideal shape and size of nozzle can be provided to draw the maximum power from the engines.

The engine may further comprise flame control means for controlling the location of the flame formed from combustion of the or each fuel within said reaction member.

In a preferred embodiment said flame control means comprises at least one flame grid.

The device may further comprise mixing means for mixing the or each fuel with the or each oxidising fluid prior to combustion.

In a preferred embodiment the mixing means mixes the or each fuel with the or each oxidising fluid prior to it entering the compression fan.

The engine may further comprise heat exchanging means for extracting heat from the gases formed from the combustion.

By providing a device with an output to a heat exchanger, the advantage is provided that the engine can be used as a combined heat and power generator. As a result, the significant heat produced by the combustion of the fuel can be utilised. A device of the type described above is significantly simpler than other combined heat and power units of the prior art. The simple rotating reaction member can be used to produce significant rotational power whilst the excess heat can be utilised through a heat exchanger and heating system. This rotational power can be converted into electricity by a generator. As a result, this type of device is particularly useful for large buildings or industrial premises which have significant heat and power requirements. By producing electrical power on site, the energy losses due to transmission from a large power station are not encountered. Such a combined heat and power unit can therefore be seen to have significant financial and environmental benefits. Alternatively the rotational power from the output shaft could be used directly to, for example, run water pumps for a heating system attached to the engine or run fan units for a larger boiler.

### BRIEF DESCRIPTION OF THE DRAWINGS

Preferred embodiments of the present invention will now be described, by way of example only, and not in any limitative sense, with reference to the accompanying drawings in which:

FIG. 1 is a schematic cross-sectional view of a gas turbine engine of the prior art;

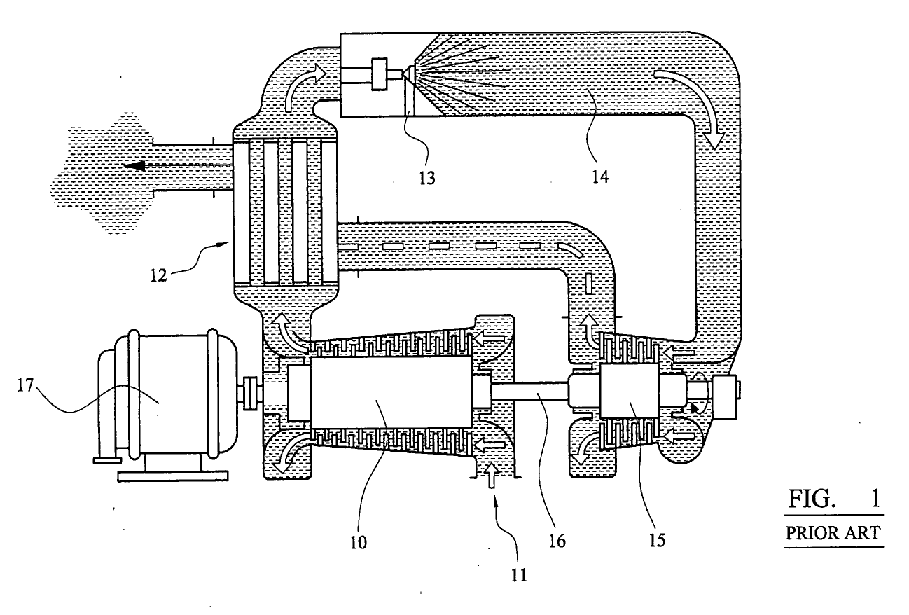

FIG. 2 is a cross-section view of an engine of a first embodiment of the present invention;

FIG. 3 is a cross-sectional view, along the line A-A, of the engine of FIG. 2;

FIG. 4 is a cross-sectional view of an engine of a second embodiment of the present invention;

FIG. 5 is a cross-sectional view of the engine of FIG. 4;

FIG. 6 is a cross-sectional view of an engine of a third embodiment of the present invention;

FIG. 7 is a perspective partial cut-away view of an engine of a fourth embodiment of the present invention; and

FIG. 8 is a perspective partial cut-away view of the engine of FIG. 7 viewed from a different angle.

### DESCRIPTION OF THE PREFERRED EMBODIMENTS

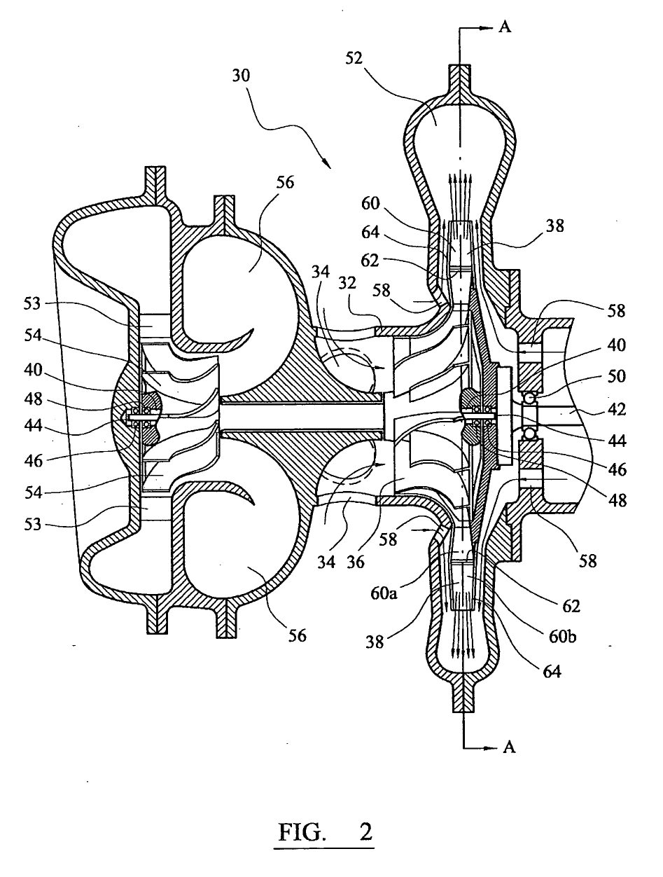

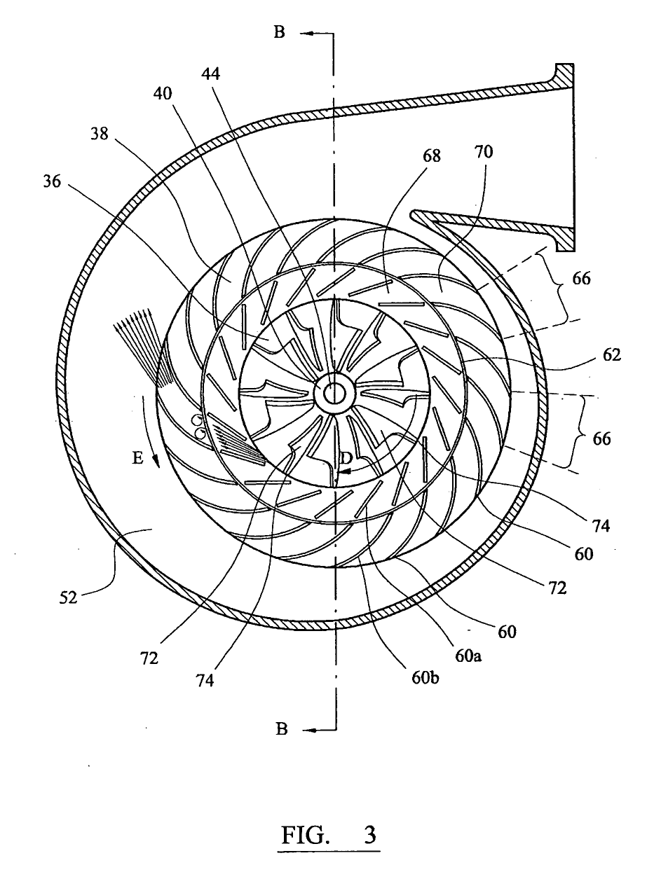

Referring to FIGS. 2 and 3 an engine 30 comprises a housing 32 having inlets 34 therein. Engine 30 also has a compression fan 36 coaxially mounted with reaction member 38. Compression fan 36 is mounted on and fixed with respect to hollow axle 40 and reaction member 38 is mounted on and fixed with respect to axle 42.

Mounted within axle 40 is a further axle (or free spindle) 44. Free spindle 44 is free to rotate relative to axle 40 and compression fan 36, and relative to axle 42 and reaction member 38, by virtue of its mounting on first bearing assemblies 46 and second bearing assemblies 48. Axle 42 is mounted on bearings 50.

Casing 32 extends around reaction member 38 to form volute 52 and extends to form a further volute which extends around nozzle ring 53. Adjacent to nozzle ring 53 is turbine wheel 54 which is connected to compression fan 36 via axle 40. The engine 30 further comprises exhausts 56.

Reaction member 38 comprises vanes 60, flame grid 62 and supporting members in the form of side casings 64. Adjacent pairs of vanes 60 define sections 66 which are themselves divided by flame grid 62 into diffusion zones 68 and combustion zones 70. Each vanes 60 may be divided into two sections, 60a and 60b, on either side of the flame grid 62. The compression fan 36 has vanes 72 which have vane tips 74.

The operation of the engine 30 shown in FIGS. 2 and 3 will now be described. It will be appreciated that FIG. 2 is a view along the line B—B in FIG. 3.

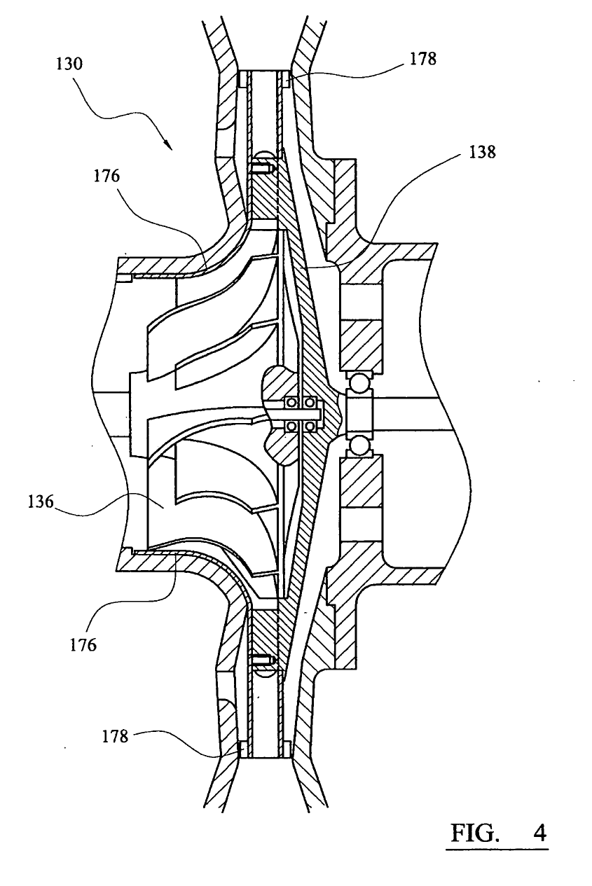

A mixture of fuel and air enters engine 30 via inlets 34. The mixture is drawn into compression fan 36 which causes an increase in the pressure of the mixture. From the compression fan 36 the mixture is directed towards the reaction member 38. The rotation of the compression fan 36 causes the vane tips 74 of vanes 72 to define a circle (which as shown in FIG. 3 approximates to the outer rim of the compression fan). The mixture is directed by the compression fan substantially tangential to this circle. Because the compression fan 36 is rotating in a first sense or direction D (as shown in FIG. 4) and the reaction member 38 is rotating in a second sense or opposite direction E, the velocity of the fuel and air mixture entering the reaction member 38, relative to the reaction member 38, is approximately the sum of the external rim velocity of the compression fan 36 and the internal rim velocity of the reaction member 36.

The reaction member 38, which encloses the compression fan 36, receives the mixture into the diffusion zone 68 between adjacent pairs of vanes 60. The geometry of the diffusion zone 68 is designed to receive the mixture at high velocity and efficiently exchange that velocity for pressure. For example, if the mixture is travelling at subsonic speeds, as the mixture enters the reaction member 38 it firstly enters the diffusion zones 68 between adjacent pairs of vanes 60. As the mixture moves radially outwards through the reaction member 38, the volume into which the mixture is moving increases, due to the radial divergence of the vanes 60. This increase in volume is exaggerated as the side casings 64 of the reaction member 38 diverge from the point of entry of the mixture. This increase in volume causes the velocity at which the mixture is travelling to reduce, which in turn increases the pressure of the mixture. Alternatively, (and not shown in the Figures) if the mixture is travelling at supersonic speeds, as the mixture enters the reaction member 38 it firstly enters the diffusion zones 68 between adjacent pairs of vanes 60. As the mixture moves radially outwards through the reaction member 38, the volume into which the mixture is moving decreases, due to the geometry of the vanes 60. This decrease in volume causes an increase in the pressure of the mixture.

This increase in pressure continues until the mixture reaches the flame grid 62. The grid 62 consists of a perforated sheet of a material which can withstand the temperatures experienced within the reaction member 38. The flame grid 62 acts as a bluff body. As the mixture passes through the perforations it is caused to increase its velocity relative to the velocity of the mixture immediately before flame grid 62. Once through the perforations in the flame grid the mixture becomes turbulent and decreases its velocity thereby filling the space immediately behind the material (non-perforated part) of the flame grid 62. Flame grid 62 marks a boundary at which combustion of the fuel air mixture occurs. The combustion takes place in the turbulent zone immediately behind the flame grid and is maintained there by the flame grid as a result of the increase in the velocity of the mixture as it passes through the perforations. This increased velocity must be greater than the flame speed of the fuel air mixture in order to retain the flame front at the flame grid 62.

The combustion of the mixture causes a rapid increase in the gaseous volume contained within the combustion zone 70 of each section 66 of reaction member 38. These gases continue through the combustion zones 70 and upon exit from the reaction member 38 apply a reaction force at a radius to the axis of the reaction member 38 turning it in an opposite direction (or sense) to the direction of movement of compression fan 36.

As the radial distance from the flame grid 62 of the reaction member 38 increases, the geometry of the combustion zone 70 is designed to suit the expanding combustion gases. The distance between the side casings 64 may be varied or the curvature of the vane 60 may be varied or a combination of both so as to control and direct the combustion gases to the exit of the combustion zone 70 of the reaction member 38 where the reaction force is generated. The curvature of the vanes 60 and the shape of the sides casings 64 are such that they create nozzles at the exit of the combustion zones 70. These nozzles are sized so as to optimise the velocity of the gases as they exit the reaction member 38. Furthermore, the nozzles are angled, by curvature of the vanes 60 so as to cause the gases to exit at an optimum angle thereby applying an optimum torque to the reaction member.

By using the compression fan to force the fuel air mixture into the section 66 of reaction member 38 at high velocity, and then initially increasing and then decreasing the volume within each section 66 and causing the combustion of the fuel air mixture adjacent the flame grid 62, approximately half way along each section 66, this causes each section to act in a similar manner to a ram-jet resulting in a efficient conversion of the combustion energy into mechanical energy.

The external surfaces of reaction member 38 are cooled by air drawn in through air inlets 58. The cooling air is entrained into the gas stream at the maximum radius of the reaction member 38.

The combusted gases from the reaction member 38 and entrained cooling air are directed via volute 52 and nozzle ring 53 towards turbine wheel 54. The velocity of the gases causes turbine wheel 54 to rotate before the excess gas is exhausted through exhaust 56. The rotation of turbine wheel 54 causes the rotation of axle 40 which is connected to compression fan 36. It is therefore the exhaust gases turning turbine wheel 54 which result in the compression of the fuel air mixture by compression fan 36.

In order to start engine 30, axle 42 is rotated. This can occur by the application of electrical power to the generator attached to axle 42, the generator thereby acting as an electric motor and causing the axle 42 to turn. Alternatively, another starter motor can be used to cause the rotation of axle 42. The resulting rotation of axle 42 causes the rotation of reaction member 38 which draws the fuel air mixture through inlets 34. Once the velocity of the fuel air mixture exiting the reaction member 38 is marginally greater than the flame speed of the mixture, the mixture is ignited. The combustion gases are directed through the turbine which drives the turbine wheel 54 which drives the compression fan 36. The speed of the reaction member 38 is then adjusted so that the flame flashes back and settles on flame grid 62. Once this has occurred the reaction member 38 will now drive the generator continuously whilst the air/fuel mixture is available.

The engine runs efficiently under a continuous load, but is not designed to provide power against a varying load. This type of engine is therefore most suitable for electricity generating and could for example be used in an electric car. The engine can be used to generate electricity to recharge batteries whilst the vehicle is moving. Although there are power losses from the conversion of mechanical to electrical energy, the efficient nature in which the engine runs make these power losses acceptable. The engine is able to run so efficiently as a result of its lack of reciprocating parts and the use of air cooling which negates the requirement for a water pump and heat exchanger with their associated losses in engine efficiency.

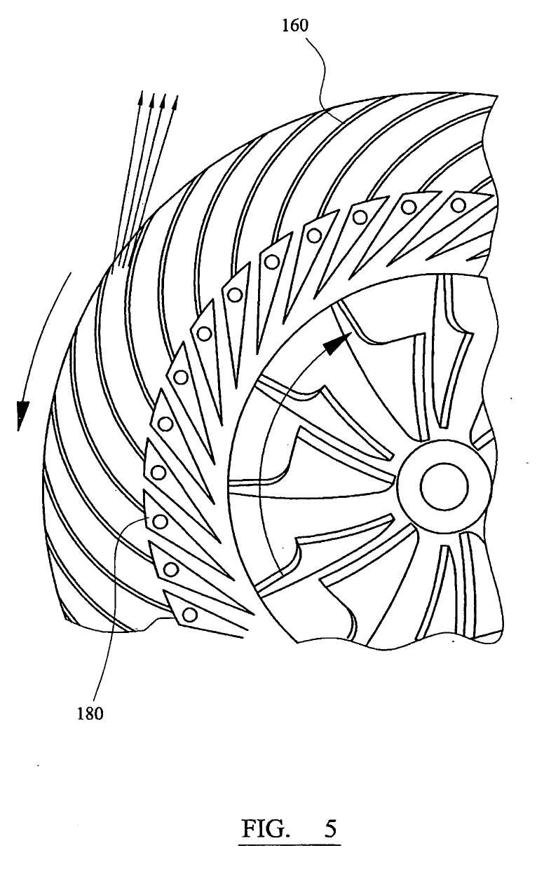

Referring to FIGS. 4 and 5, in which parts common to the embodiment of FIGS. 2 and 3 are denoted by like reference numerals but increased by 100, an engine 130 has a compression fan 136 and a reaction member 138. A side casing 164 extends, at 176, to partially enclose compression fan 136. By enclosing the compression fan within the reaction member, the transfer of the fuel and air mixture is more efficient.

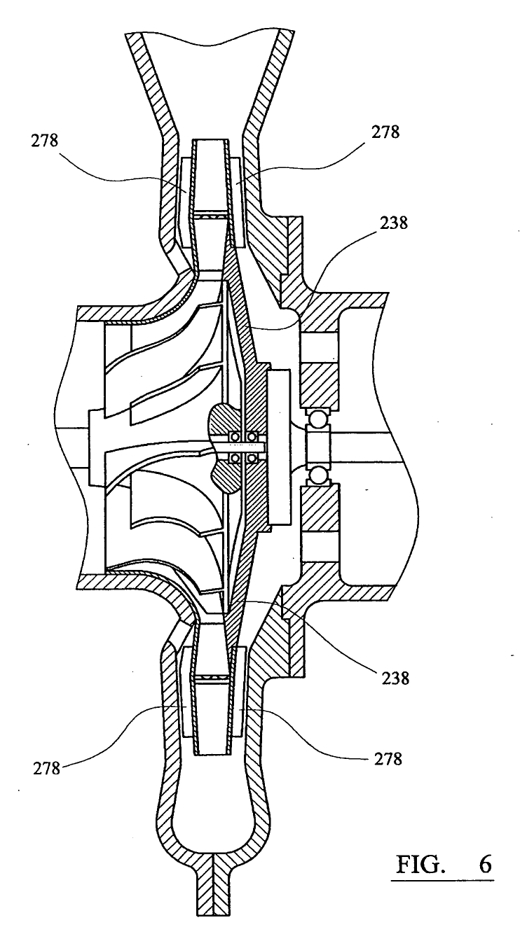

The reaction member 138 also has further vanes 178, which assist the entrainment of the cooling air, actively drawing it into the engine. As an alternative to the frame grid 62 (in FIGS. 2 and 3), the vanes 160 are thickened at 180 so as to reduce the cross-sectional area, measured in a circumferential direction, of the space defined by two adjacent vanes, until the point were the frame front is to be ideally located, and then the cross-sectional area rapidly increases again. This shape has the effect of acting as a single bluff-body as opposed to the multiple bluff-body resulting from the flame grid. The fuel air mixture increases its velocity as cross-sectional area between the vanes decreases. The space between the vanes is reduced so as to increase the velocity of the fuel such that it is faster than the flame speed of the fuel/air mixture and thus the flame front is maintained at this location. Referring to FIG. 6, in which parts common to the embodiment of FIGS. 4 and 5 are denoted by like reference numerals but increased by 100, reaction member 238 has further vanes 278. The length and location of these further vanes specifically compresses the cooling air to a pressure approximately equal to the pressure of the combustion gases resulting from the burning of the fuel air mixture as they leave the reaction member 238. Attached, in Annexes I and II, are set point calculations for the temperatures and pressures throughout the process and an engine efficiency is also calculated. The calculations in Annexe I are based on the assumption that the secondary compression, occurring in between the first sections 60a of vanes 60 in reaction member 38, is a ram compression. The calculations in Annexe II are based on the assumption that the secondary compression is diffusion compression.

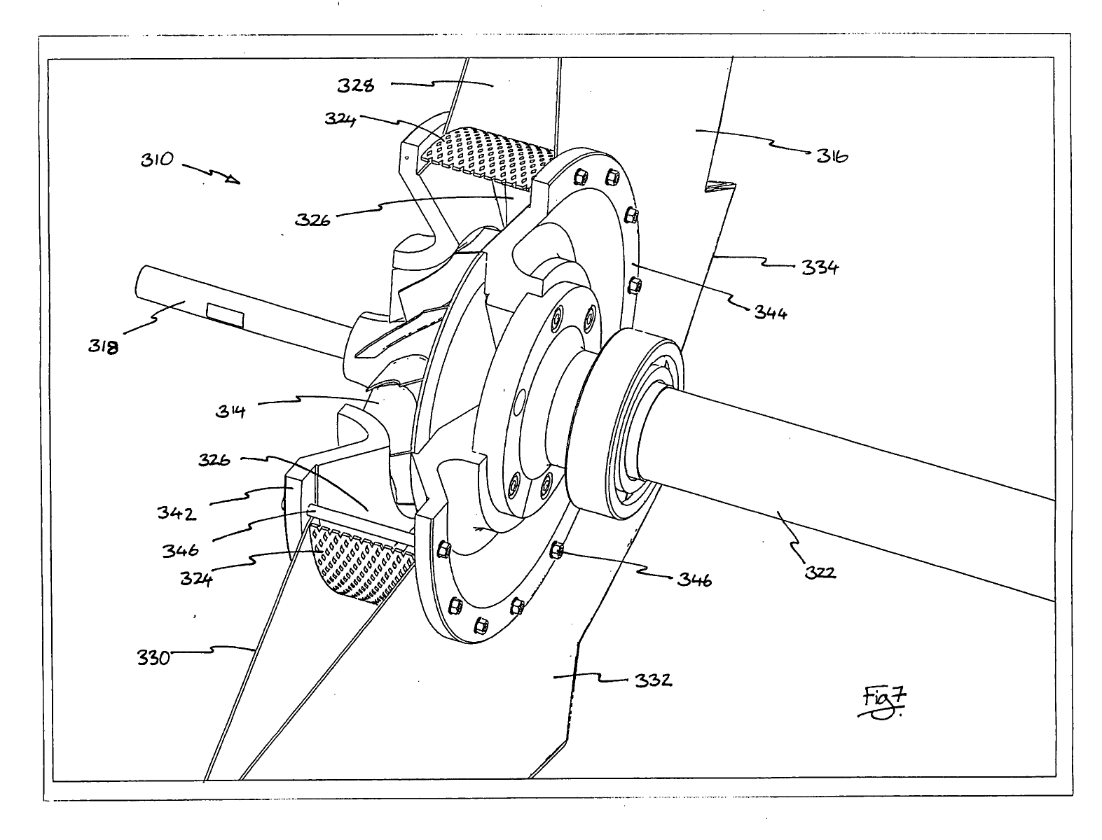

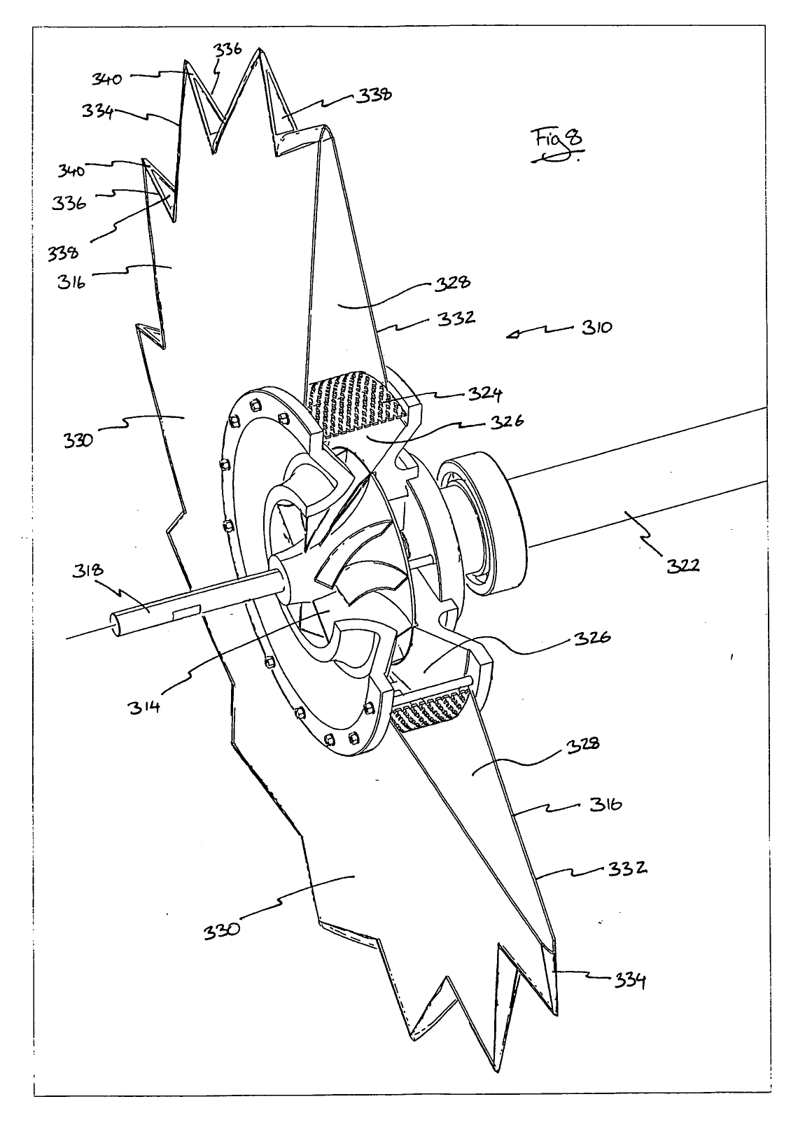

Referring to FIGS. 7 and 8, an engine 310 has a housing (not shown) enclosing a compression device in the form of compression fan 314 and a reaction member 316. The compression fan 314 is caused to rotate about axle 318 by a driving device (not shown). This driving device might be a turbine driven by exhaust gases from the engine or might alternatively be an electrical motor which could be powered by a portion of the electrical power produced by a generator attached to the engine.

The reaction member 316 is mounted coaxially with compression fan 314 on an output drive axle 322. The output drive axle 322 can be connected to an electrical generator such as a permanent magnet AC brushless generator (not shown). The reaction member 316 is divided into two radially separated portions by a flame control device or flame grid 324. Between the compression fan 314 and the flame grid 324 is a diffusion zone 326. Radially beyond the flame grid 324 is a single combustion zone 328. The reaction member is formed from two substantially circular discs 330 and 332 which have a saw tooth shape as a result of the radially peripheral edges 334 and 336. The longer edges 334 are folded towards each other and welded to each other thereby forming substantially triangular nozzles 338 which act as an outlet from combustion zone 328. The precise size and dimensions of the nozzles 338 are determined by nozzle shapers 340 which are welded between edges 336 so as to provide reinforcement for the nozzles 338. The nozzle shapers ensure that the shape of the nozzle is maintained in the event of distortion of the reaction member as a result of thermal fatigue.

The reaction member also includes plates 342 and 344 which are bolted to each other by bolts 346 and thereby hold discs 330 and 332 in compressive connection with flame grid 324. Plate 342 has an opening 348 through which fuel is introduced into the compression fan 314.

In use, a mixture of a fuel, for example propane and an oxidising gas, for example air, are drawn into the compression fan 314 through opening 348. Axle 318 is rotated by the fan driver (not shown) which in turn causes rotation of the compression fan 314. As a result of this rotation, the fuel and air mixture is compressed and forced radially into the reaction member 316. The fuel and air mixture initially enters the diffusion zone 326 of reaction member 316 and as the mixture continues to move radially outwards, the increasing passage width and increasing radial distance causes the mixture to slow down, thereby increasing its pressure. This increase continues until the fuel and air mixture reaches the flame grid 324 and passes through the small apertures therein.

On passing through the flame grid 324, the mixture enters the combustion zone 328 where the fuel is burnt. Initial ignition of the mixture can result from a spark from a piezo-electric ignitor which causes the flame to flash back and settle immediately adjacent, and radially outward of, the flame grid 324. The burning of the fuel causes a significant increase in the volume of the gas which continues to travel radially outward within the combustion zone 328 of reaction member 316. Upon reaching the outer edge 334 of reaction member 316, the combusted gases are directed towards nozzle 338 from where they exit the reaction member 316. The nozzles 338 are sized so as to apply the maximum reaction force to the reaction member at each nozzle.

Because the hot combustion gases only come into direct contact with the discs 330 and 332 within the combustion zone 328, simple cooling vanes (not shown) attached to the outside surfaces of discs 330 and 332 are able to direct cooling air over these surfaces maintaining the discs at an acceptable working temperature. This cooling air mixes with the hot combustion gases as the exit nozzles 338 within the housing (not shown) from where they are directed to a heat exchanger (not shown). The heat exchanger extracts heat from the combustion gases and uses it in a heating system whilst the rotational output on output drive axle 322 is utilised for example by driving a generator to produce electricity. It is worth noting that even though the flame grid is located within the volume of the reaction member where combustion takes place and does not have any external surfaces, it should not require separate cooling as the mixture of fuel and air act to cool the grid as they pass through it.

It will be appreciated by persons skilled in the art that the above embodiment has been described by way of example only, and not in any limitative sense, and that various alterations and modifications are possible without departure of the scope of the invention as defined by the appended claims. For example, it is possible that the fuel and air may not be mixed prior to entering the compression fan and that air is introduced either within the diffusion zone or combustion zone of the reaction member 316. Alternatively, the air could be compressed within a compression fan and fuel introduced within the reaction member. The disc 330 and plate 342 could be formed as a single part of reaction member 316 as could disc 328 and plate 344. These single parts could then be welded together to form the reaction member. As an alternative to the perforated flame grid a single annular aperture or a circumferential line of holes could be provided in a sheet located where the flame grid is shown to act as a flame control means. The purpose of this element of the engine is to hold the flame in a controlled position. It should also be noted that other shapes of nozzle may be equally, or more, suitable than the triangular nozzles shown.

### TanJet Engine. Set Point Calculations.

It is assumed that petrol fuel is vaporised And mixed with air at a ratio of 22:1 prior to the impeller. The temperature of combustion will be in the region of 2180° K and cooling air is entrained after the tangential jet reaction. A mass flow of 0.25 Kg/sec is assumed. Ratio of specific heats is taken as 1.333 for air/fuel mixture and a C_{pSAS} value of 1.150 KJ/Kg.K

1/ Compression. (Impeller)

A slip factor of 0.835 is calculated for a 12 vane impeller. The impeller peripheral speed U₁ is 460 m/s; Inlet temperature is 288° K: Inlet pressure is 1.01 bar. An isentropic efficiency of 81% is assumed (ie 90% impeller ×90% diffuser) over the whole compression process.

$$\begin{matrix}\begin{matrix}Mass flow of \\ air \text{/} fuel mix\end{matrix} ; & {m}_{mix} := 0.25 \cdot \frac{kg}{sec} & \\ \begin{matrix}Ratio of \\ specific heats\end{matrix} ; & γ := 1.333 & \\ \begin{matrix}Specific \\ heat ( gas )\end{matrix} ; & {C}_{pGAS} := 1150 \cdot \frac{joule}{kg \times K .} & \\ Slip factor ; & σ := 0.835 & \\ \begin{matrix}Compressor \\ efficiency\end{matrix} ; & {η}_{compressor} := 0.90 & \\ \begin{matrix}Inlet \\ temperature\end{matrix} ; & {T}_{1} := 288 \cdot K . & \\ Inlet pressure ; & {P}_{1} := 1.01 \times {10}^{5} \cdot Pa & \\ \begin{matrix}Compressor \\ rim velocity\end{matrix} ; & {U}_{1} := 460 \cdot \frac{m}{sec} & \\ \begin{matrix}Temperature \\ after impeller\end{matrix} ; & {T}_{2} := {T}_{1} + \frac{σ \times {U}_{1}^{2}}{{C}_{pGAS}} & {T}_{2} = 441.64 K . \\ \begin{matrix}Ideal temperature \\ after impeller\end{matrix} ; & \begin{matrix}{T}_{ \_ 2} := {T}_{ 1} + \\ [ ( {T}_{ 2} - {T}_{ 1} ) \times {η}_{ compressor} ]\end{matrix} & {T}_{\_ 2} = 426.276 K . \\ \begin{matrix}Pressure \\ after impeller\end{matrix} ; & {P}_{2} \text{:} := {P}_{1} \times {( \frac{{T}_{\_ 2}}{{T}_{1}} )}^{\frac{γ}{γ - 1}} & {P}_{2} = 4.853 \times {10}^{5} Pa \\ \begin{matrix}Compressor \\ power required\end{matrix} ; & \begin{matrix}{Power}_{ com} := {m}_{ mix} \times \\ {C}_{ pGAS} \times ( {T}_{ 2} - {T}_{ 1} )\end{matrix} & \\ & {Power}_{com} = 4.417 \times {10}^{4} watt & \end{matrix}$$

2/ Compression. (Diffuser)

Air/fuel mixture leaves the compressor and enters the reaction wheel diffusion zone at a combined velocity of U₁+U₂ and the velocity prior to combustion is U₃ relative to the reaction wheel. The velocity of the mixture entering the diffuser is higher due to the rotation of the reaction wheel in the opposite direction to the impeller. An isentropic efficiency of 81% is assumed for the whole of the compression process. (ie 90% impeller x 90% diffuser)

$$\begin{matrix}Inner rim velocity ; & {U}_{2} := 150 \cdot \frac{m}{sec} & \\ \begin{matrix}Velocity prior \\ to combustion\end{matrix} ; & {U}_{3} := 75 \cdot \frac{m}{sec} & \\ Diffuser efficiency ; & {η}_{diffuser} := 0.90 & \\ \begin{matrix}Temperature after \\ diffusion\end{matrix} ; & \begin{matrix}[ \frac{{[ ( 0.835 \times {U}_{1} ) + {U}_{2} ]}^{2}}{2 \times {C}_{pGAS}} ] - \\ ( \frac{{U}_{3}^{2}}{2 \times {C}_{pGAS}} ) + {T}_{2}\end{matrix} & \\ & {T}_{3} = 563.222 K & \\ \begin{matrix}Ideal temperature \\ after diffusion\end{matrix} ; & \begin{matrix}{T}_{ \_ 3} := {T}_{ 2} + \\ [ ( {T}_{ 3} - {T}_{ 2} ) \times {η}_{ diffuser} ]\end{matrix} & {T}_{\_ 3} = 551.063 K . \\ Pressure after diffusion ; & {P}_{3} := {P}_{2} \times {( \frac{{T}_{\_ 3}}{{T}_{2}} )}^{\frac{γ}{γ - 1}} & {P}_{3} = 1.177 \times {10}^{6} Pa \\ \begin{matrix}Diffusion \\ pressure ratio\end{matrix} ; & \frac{{P}_{3}}{{P}_{2}} = 2.426 & \\ O \text{/} all pressure ratio ; & \frac{{P}_{3}}{{P}_{1}} = 11.655 & \\ \begin{matrix}Power required \\ from reaction \\ wheel for \\ ram compression\end{matrix} ; & \begin{matrix}{Power}_{ ram} : = {m}_{ mix} \times \\ {C}_{ pGAS} \times ( {T}_{ 3} - {T}_{ 2} )\end{matrix} & \\ & {Power}_{ram} = 3.495 \times {10}^{4} watt & \end{matrix}$$

3/ Temperature of Combustion.

A combustion efficiency of 95% is assumed and the pressure drop is 5% of pressure P₃. The calorific value of petrol fuel is 43 MJ/Kg and the afr is 22:1.

$$\begin{matrix}Air \text{/} Fuel ratio ; & afr := 22 & \\ Fuel calorific value ; & {Fuel}_{cv} := 43 \times {10}^{6} \times \frac{joule}{kg} & \\ \begin{matrix}Combustion \\ efficiency\end{matrix} & {η}_{combustion} := 0.95 & \\ Energy supplied ; & {Heat}_{i n} := \frac{\begin{matrix}{m}_{ mix} \times {Fuel}_{ cv} \times \\ {η}_{ combustion}\end{matrix}}{afr} & {Heat}_{i n} = \begin{matrix}4.642 \times \\ {10}^{5} \frac{joule}{sec}\end{matrix} \\ \begin{matrix}Temperature after \\ Cumbustion\end{matrix} ; & {T}_{4} := {T}_{3} + \frac{{Heat}_{i n}}{{m}_{mix} \times {C}_{pGAS}} & {T}_{4} = 2.178 \times {10}^{3} K . \\ \begin{matrix}Pressure after \\ Combustion\end{matrix} ; & {P}_{4} := {P}_{3} \times ( 1 - 0.05 ) & {P}_{4} = 1.118 \times {10}^{6} Pa\end{matrix}$$

4/ Tangential Reaction.

The hot pressurised gas is to partially expand through the tangential nozzles, the reaction from which, will cause the reaction wheel to rotate and provide useful output power. The power output reaction factor is adjusted iteratively to ensure that enough energy is left in the fluid to power the turbine. (The power output represents the useful shaft power output+the ram diffuser effort (section 2 ) +the cooling air delivery effort (section 5).) An isentropic efficiency of 90% is assumed for the reaction nozzles.

$$\begin{matrix}Nozzle efficiency ; & {η}_{reaction} := 0.90 & \\ \begin{matrix}Power output \\ reaction factor\end{matrix} ; & {RF}_{power} := 0.4835 & \\ \begin{matrix}Power out ; \\ ( Power out is shaft \\ power + ram diffuser \\ effort + cooling air \\ delivery effort . )\end{matrix} & \begin{matrix}{Power}_{ out} := {RF}_{ power} \times \\ {Heat}_{ i n}\end{matrix} & \begin{matrix}{Power}_{ out} = 2.244 \times \\ {10}^{ 5} watt\end{matrix} \\ \begin{matrix}Temperature prior \\ to reaction\end{matrix} ; & {T}_{4} = 2.178 \times {10}^{3} K . & \\ {Temp}^{′} after reaction ; & {T}_{5} := {T}_{4} - \frac{{Power}_{out}}{{m}_{mix} \times {C}_{pGAS}} & {T}_{5} = 1.397 \times {10}^{3} K . \\ Temperature drop ; & {T}_{4} - {T}_{5} = 780.671 K & \\ \begin{matrix}Ideal {temp}^{′} after \\ reaction\end{matrix} ; & {T}_{\_ 5} := {T}_{4} - \frac{( {T}_{4} - {T}_{5} )}{{η}_{reaction}} & {T}_{\_ 5} = 1.31 \times {10}^{3} K . \\ \begin{matrix}Pressure before \\ reaction\end{matrix} ; & {P}_{4} = 1.118 \times {10}^{6} Pa & \\ Pressure after reaction ; & {P}_{5} := {P}_{4} \times {( \frac{{T}_{\_ 5}}{{T}_{4}} )}^{\frac{γ}{γ - 1}} & {P}_{5} = 1.464 \times {10}^{5} Pa\end{matrix}$$

5/ Reaction wheel Cooling.

The hot pressurised gas is contained within the walls of the rotating reaction wheel Cooling air is delivered across the walls by radial vanes attached to the out side of the reaction wheel. The vanes act like an impeller and are designed to deliver the cooling air at the same pressure as the hot combustion gases after partial expansio through the nozzles. This cooling air is entrained by the high velocity of the primary combustion gases emerging at the reaction radius. The total mass flow is estimated at 2.75 times the initial mass flow because an AFR of 60.5:1 (2.75 ×22) would give a cooler combustion temperature of 1150° K. The cooling air entering the system is at 288° K and the CD value is 1.005 KJ/Kg.K. Ratio of specific heats for air is taken as 1.4

$$\begin{matrix}Total mass flow ; \\ ( after reaction wheel )\end{matrix} \qquad {m}_{total} := 2.75 \times {m}_{mix} \qquad {m}_{total} = 0.688 \frac{kg}{sec}$$

Assuming that the outer vanes on the reaction wheel are similar in configuration to the impeller then the slip factor will be the same and the calculation will be similar to section one. The efficiency will be lower, say 80%

$$\begin{matrix}Mass flow ; & {m}_{coolair} := {m}_{total} - {m}_{mix} & \\ \begin{matrix}Cool air vanes \\ efficiency\end{matrix} ; & {η}_{vanes} := 0.80 & \\ \begin{matrix}Ratio of {spec}^{ ′} \\ heats\end{matrix} ; & {γ}_{air} := 1.4 & \\ Inlet temperature ; & {T}_{1} := 288 \times K & \\ Specific heat ( air ) ; & {C}_{pAIR} := 1005 \cdot \frac{joule}{kg \times K} & \\ Inlet pressure ; & {P}_{1} := 1.01 \times {10}^{5} \cdot Pa & \\ \begin{matrix}Pressure after \\ vanes\end{matrix} ; & {P}_{vtips} := {P}_{5} & \begin{matrix}{P}_{ vtips} = 1.464 \times \\ {10}^{5} Pa\end{matrix} \\ Slip factor ; & σ := 0.835 & \\ \begin{matrix}Ideal temperature \\ after vanes\end{matrix} ; & {T}_{vtips} := {T}_{1} \times {( \frac{{P}_{vtips}}{{P}_{1}} )}^{\frac{{γ}_{air} - 1}{{γ}_{air}}} & {T}_{ vtips} = 320.208 K . \\ \begin{matrix}Temperature \\ after vanes\end{matrix} ; & {T}_{vtips} := \begin{matrix}{T}_{ 1} + \\ [ \frac{( {T}_{ \_vtips} - {T}_{ 1} )}{ {η}_{ vanes}} ]\end{matrix} & {T}_{vtips} = 328.26 K . \\ \begin{matrix}Vanes rim \\ velocity\end{matrix} ; & {U}_{vanes} := \sqrt{\frac{[ \begin{matrix}( {T}_{ vtips} - {T}_{ 1} ) \times \\ {C}_{pAIR}\end{matrix} ]}{σ}} & {U}_{vanes} = 220.129 \frac{m}{sec} \\ \begin{matrix}Cooling air \\ delivery effort\end{matrix} ; & \begin{matrix}{Power}_{ vanes} := {m}_{ coolair} \times \\ {C}_{ pAIR} \times ( {T}_{vtips} - {T}_{ 1} )\end{matrix} & \\ & {Power}_{vanes} = 1.77 \times {10}^{4} watt & \\ \begin{matrix}Temperature after \\ entertainment of \\ cooling air \\ with gas\end{matrix} ; & {T}_{5 e} := \frac{[ \begin{matrix}( {m}_{mix} \times {C}_{pGAS} \times \\ {T}_{ 5} ) + ( {m}_{ coolair} \times \\ {C}_{pAIR} \times {T}_{vtips} )\end{matrix} ]}{\begin{matrix}( {m}_{coolair} \times {C}_{pAIR} ) - \\ ( {m}_{mix} \times {C}_{pGAS} )\end{matrix}} & \\ & {T}_{5 e} = 750.865 K . & \end{matrix}$$

6/ Turbine.

The gas is to expand further through the turbine. The power required at the turbine is to match the power required for the compressor. (This is accomplished by adjustment of the power output reaction factor.) An isentropic efficiency of 85% is assumed for a turbine with constant mass flow.

$$\begin{matrix}\begin{matrix}Final {press}^{′} is \\ same as initial \\ {press}^{′}\end{matrix} ; & {P}_{6} := {P}_{1} & {m}_{ total} = 0.688 \frac{kg}{ sec} \\ Turbine efficiency ; & {η}_{turbine} := 0.85 & {P}_{ 5} = 1.464 \times {10}^{ 5} Pa \\ \begin{matrix}Ideal {temp}^{′} after \\ expansion\end{matrix} ; & {T}_{\_ 6} := {T}_{5 e} \times {( \frac{{P}_{6}}{{P}_{5}} )}^{\frac{γ - 1}{γ}} & {T}_{\_ 6} = 684.396 K . \\ \begin{matrix}{Temp}^{ ′} after \\ expansion\end{matrix} ; & \begin{matrix}{T}_{ 6} := {T}_{ 5 e} - \\ [ ( {T}_{ 5 e} - {T}_{ \_ 6} ) \times {η}_{ turbine} ]\end{matrix} & {T}_{6} = 694.366 K . \\ Turbine power output ; & \begin{matrix}{Power}_{ turb} := {m}_{ total} \times \\ {C}_{ pGAS} \times ( {T}_{ 5 e} - {T}_{ 6} )\end{matrix} & \\ & {Power}_{turb} = 4.467 \times {10}^{4} watt & \\ \begin{matrix}Compressor power \\ required\end{matrix} ; & {Power}_{com} = 4.417 \times {10}^{4} watt & \\ Engine efficiency ; & {E}_{oall} := \frac{( \begin{matrix}{Power}_{out} - \\ {Power}_{ ram} - \\ {Power}_{ vanes}\end{matrix} )}{{Heat}_{i n}} & {E}_{oall} = 37.007 \% \\ Shaft power output ; & \begin{matrix}{Power}_{ out} - {Power}_{ ram} - \\ {Power}_{ vanes} = \\ 1.718 \times {10}^{ 5} watt\end{matrix} & \\ \begin{matrix}Turbine / compressor \\ power ratio\end{matrix} ; & \frac{{Power}_{turb}}{{Power}_{com}} = 1.011 & \end{matrix}$$

### TanJet Engine. Set Point Calculations.

It is assumed that petrol fuel is vaporised and mixed with air at a ratio of 22:1 prior to the impeller. The temperature of combustion will be in the region of 21750° K and cooling air is entrained after the tangential jet reaction. A mass flow of 0.25 Kg/sec is assumed. Ratio of specific heats is taken as 1.333 for air/fuel mixture and a C_{PGAS} value of 1.150 KJ/Kg.K

1/ Compression. (Impeller)

A slip factor of 0.835 is calculated for a 12 vane impeller. The impeller peripheral speed U₁, is 460 m/s; Inlet temperature is 288° K; Inlet pressure is 1.01 bar. An isentropic efficiency of 81% is assumed (ie 90% impeller ×90% diffuser) over the whole compression process.

$$\begin{matrix}Mass flow ; & {m}_{mix} := 0.25 \times \frac{kg}{sec} & \\ Ratio of {spec}^{′} heats ; & γ := 1.333 & \\ Specific heat ( gas ) ; & {C}_{pGAS} := 11.50 \times \frac{joule}{kg \times K .} & \\ Slip factor & σ := 0.835 & \\ Compressor efficiency ; & {η}_{compressor} := 0.90 & \\ Inlet temperature ; & {T}_{1} := 288 \times K . & \\ Inlet pressure ; & {P}_{1} := 1.01 \times {10}^{5} \times Pa & \\ \begin{matrix}Compressor rim \\ velocity\end{matrix} ; & {U}_{1} := 460 \times \frac{m}{sec} & \\ \begin{matrix}Temperature after \\ impeller\end{matrix} ; & {T}_{2} := {T}_{1} + \frac{σ \times {U}_{1}^{2}}{{C}_{pGAS}} & {T}_{2} = 441.64 K . \\ \begin{matrix}Ideal temperature \\ after impeller\end{matrix} ; & \begin{matrix}{T}_{ \_ 2} := {T}_{ 1} + \\ [ ( {T}_{ 2} - {T}_{ 1} ) \times {η}_{ compressor} ]\end{matrix} & {T}_{\_ 2} = 426.276 K . \\ \begin{matrix}Pressure after \\ impeller\end{matrix} ; & {P}_{2} := {P}_{1} \times {( \frac{{T}_{\_ 2}}{{T}_{1}} )}^{\frac{γ}{γ - 1}} & {P}_{2} = 4.853 \times {10}^{5} Pa \\ \begin{matrix}Compressor power \\ required\end{matrix} ; & \begin{matrix}{Power}_{ com} := {m}_{ mix} \times \\ {C}_{ pGAS} \times ( {T}_{ 2} - {T}_{ 1} )\end{matrix} & \\ & {Power}_{com} = 4.417 \times {10}^{4} watt & \end{matrix}$$

$$\begin{matrix}\begin{matrix}Inner rim \\ velocity\end{matrix} ; & {U}_{2} := 150 \times \frac{m}{sec} & \\ \begin{matrix}Compression \\ efficiency\end{matrix} ; & {η}_{compression} := 0.81 & \\ \begin{matrix}{Temp}^{′} after \\ diffusion\end{matrix} ; & {T}_{3} := \frac{σ \times {( {U}_{1} + {U}_{2} )}^{2}}{{C}_{pGAS}} + {T}_{1} & {T}_{3} = 558.177 K . \\ \begin{matrix}Ideal {temp}^{′} \\ after diffusion\end{matrix} ; & \begin{matrix}{T}_{\_ 3} := {T}_{ 1} + \\ [ ( {T}_{3} - {T}_{1} ) \times {η}_{compression} ]\end{matrix} & {T}_{\_ 3} = 506.843 K . \\ \begin{matrix}Pressure after \\ diffusion\end{matrix} ; & {P}_{3} := {P}_{1} \times {( \frac{{T}_{\_ 3}}{{T}_{1}} )}^{\frac{γ}{γ - 1}} & {P}_{3} = 9.705 \times {10}^{5 } Pa Pa \\ \begin{matrix}Diffusion pressure \\ ratio\end{matrix} ; & \frac{{P}_{3}}{{P}_{2}} = 2 & \\ \begin{matrix}O \text{/} all pressure \\ ratio\end{matrix} ; & \frac{{P}_{3}}{{P}_{1}} = 9.609 & \\ \begin{matrix}Effort {req}^{'} d from \\ reaction wheel \\ for diffusion\end{matrix} ; & \begin{matrix}{Power}_{ram} := {m}_{ mix} \times \\ {C}_{pGAS} \times ( {T}_{3} - {T}_{2} )\end{matrix} & \\ & {Power}_{ram} = 3.35 \times {10}^{4} watt & \end{matrix}$$

2/ Compression. (Diffuser)

Air/fuel mixture leaves the compressor and enters the reaction wheel diffusion zone at a combined velocity of U₁ +U₂ relative to the diffuser. The velocity of the mixture entering the diffuser is higher due to the rotation of the reaction wheel in the opposite direction to the impeller. An isentropic efficiency of 81% is assumed (ie 90% impeller x 90% diffuser) over the whole compression process.

3/ Temperature of Combustion.

A combustion efficiency of 95% is assumed and the pressure drop is 5% of pressure P₃. The calorific value of petrol fuel is 43 MJ/Kg and the afr is 22:1.

$$\begin{matrix}Air \text{/} Fuel ratio ; & afr := 22 & \\ \begin{matrix}Fuel calorific \\ value\end{matrix} ; & {Fuel}_{cv} := 43 \times {10}^{6} \times \frac{joule}{kg} & \\ \begin{matrix}Combustion \\ efficiency\end{matrix} ; & {η}_{combustion} := 0.95 & \\ \begin{matrix}Energy \\ Supplied\end{matrix} ; & {Heat}_{i n} := \frac{\begin{matrix}{m}_{mix} \times {Fuel}_{cv} \times \\ {η}_{combustion}\end{matrix}}{afr} & {Heat}_{i n} = 4.642 \times {10}^{5} \frac{joule}{sec} \\ \begin{matrix}Temperature \\ after \\ Combustion\end{matrix} : & {T}_{4} := {T}_{3} + \frac{{Heat}_{i n}}{{m}_{mix} \times {C}_{pGAS}} & {T}_{4} .173 \times {10}^{3} K . \\ \begin{matrix}Pressure after \\ Combustion\end{matrix} ; & {P}_{4} := {P}_{3} \times ( 1 - 0.05 ) & {P}_{4} = 9.219 \times {10}^{5} Pa\end{matrix}$$

4/ Tangential Reaction.

The hot pressurised gas is to partially expand through the tangential nozzles, the reaction from which, will cause the reaction wheel to rotate and provide useful output power. The power output reaction factor is adjusted iteratively to ensure that enough energy is left in the fluid to power the turbine. (The power output represents the useful shaft power output+the ram diffuser effort (section 2) +the cooling air delivery effort (section 5).) An isentropic efficiency of 90% is assumed for the reaction nozzles.

$$Nozzle efficiency ; {η}_{reaction} := 0.9$$

$$Power output reaction factor ; {RF}_{power} := 0.45$$

$$Power out ; ( Power out is shaft power + ram diffuser effort + cooling air delivery effort . )$$

$${Power}_{out} := {RF}_{power} \times {Heat}_{in} {Power}_{out} = 2.089 \times {10}^{5} watt$$

$$Temperature prior to reaction ; {T}_{4} = 2.173 \times {10}^{3} K$$

$$Temp ' after reaction ; {T}_{5} := {T}_{4} - \frac{{Power}_{out}}{{m}_{mix} \times {C}_{pGAS}} {T}_{5} = 1.446 \times {10}^{3} K$$

$$Temperature drop ; {T}_{4} - {T}_{5} = 703.976 K$$

$$Ideal temp ' after reaction ;$$

$${T}_{\_ 5} := {T}_{4} - \frac{( {T}_{4} - {T}_{5} )}{{η}_{reaction}} {T}_{\_ 5} = 1.365 \times {10}^{3} K$$

$$Pressure before reaction ; {P}_{4} = 9.219 \times {10}^{5} Pa$$

$$Pressure after reaction ; {P}_{5} := {P}_{4} \times {( \frac{{T}_{\_ 5}}{{T}_{4}} )}^{\frac{γ}{γ - 1}} {P}_{5} = 1.436 \times {10}^{5} Pa$$

5/ Reaction wheel Cooling.

The hot pressurised gas is contained within the walls of the rotating reaction wheel. Cooling air is delivered across the walls by radial vanes attached to the out side of the reaction wheel. The vanes act like an impeller and are designed to deliver the cooling air at the same pressure as the hot combustion gases after partial expansion through the nozzles. This cooling air is entrained by the high velocity of the primary combustion gases emerging at the reaction radius. The cooling air entering the system is at 288° K and the CD value is 1.005 KJ/Kg.K Ratio of specific heats is taken as 1.4 for air

$$Total mass flow ; ( guessed ) ( after reaction wheel )$$

$${m}_{total} := 3 \times {m}_{mix} {m}_{total} = 0.75 \frac{kg}{sec}$$

Assuming that the outer vanes on the reaction wheel are similar in configeration to the impellor then the slip factor will be the same and the calculation will be similar to section one. The efficiency will be lower, say 80%

$$Mass flow ; {m}_{air} := {m}_{total} - {m}_{mix }$$

$$Cool air vanes efficiency ; {η}_{vanes} := 0.80$$

$$Ratio of spec ' heats ; {Y}_{air} := 1.4$$

$$Inlet temperature ; {T}_{1} := 288 \times K$$

$$Specific heat ( air ) ; {C}_{p AIR} := 1005 \times \frac{joule}{kg \times K}$$

$$Inlet pressure ; {P}_{1} := 1.01 \times {10}^{5} \times Pa$$

$$Pressure after vanes ; {P}_{vtips} := {P}_{5} {P}_{vtips} = 1.436 \times {10}^{5} Pa$$

$$Slip factor ; σ := 0.835$$

$$Ideal temperature after vanes ;$$

$${T}_{vtips} := {T}_{1} \times {( \frac{{P}_{vtips}}{{P}_{1}} )}^{\frac{{γ}_{air} - 1}{{γ}_{air}}} {T}_{\_ vtips} = 318.467 K$$

$$Temperature after vanes ;$$

$${T}_{vtips} := {T}_{1} + [ \frac{{T}_{\_ vtip s} - {T}_{1}}{{η}_{vanes}} ] {T}_{vtips} = 326.084 K$$

$$Vanes rim velocity ;$$

$${U}_{vanes} := \sqrt{\frac{⌊ ( {T}_{vtips} - {T}_{1} ) \times {C}_{p AIR} ⌋}{σ}} {U}_{vanes} = 214.097 \frac{m}{sec}$$

$$Cooling air delivery effort ;$$

$${Power}_{vanes} := {m}_{air} \times {C}_{p AIR} \times ( {T}_{vtips} - {T}_{1} ) {Power}_{vanes} = 1.914 \times {10}^{4} watt$$

$$Temperature after entrainment of cooling air with gas ;$$

$$\begin{matrix}{T}_{5 e} := \frac{[ ( {m}_{mix} \times {C}_{p GAS} \times {T}_{5} ) + ( {m}_{air} \times {C}_{p AIR} \times {T}_{vtips} ) ]}{( {m}_{air} \times {C}_{p AIR} ) + ( {m}_{mix} \times {C}_{p GAS} )} \\ {T}_{5 e} = 733.729 K\end{matrix}$$

6/ Turbine.

The gas is to expand further through the turbine. The power required at the turbine is to match the power required for the compressor. (This is accomplished by adjustment of the power output reaction factor.) An isentropic efficiency of 85% is assumed for the turbine.

$$Final press ' is same as initial press ' ;$$

$${P}_{6} := {P}_{1} {m}_{total} = 0.75 \frac{kg}{sec} {P}_{ 5} = 1.436 \times {10}^{ 5} Pa$$

$$Turbine efficiency ; {η}_{turbine} := 0.85$$

$$Ideal temp ' after expansion ; {T}_{\_ 6} := {T}_{5 e} \times ( \frac{{P}_{6}}{{P}_{5}} ) {T}_{\_ 6} = 671.972 K$$

$$Temp ' after expansion ;$$

$${T}_{6} := {T}_{5 e} - [ ( {T}_{5 e} - {T}_{\_ 6} ) \times {η}_{turbine} ] {T}_{6} = 681.235 K$$

$$Turbine power output ;$$

$${Power}_{turb} := {m}_{total} \times {C}_{p GAS} \times ( {T}_{5 e} - {T}_{6} ) {Power}_{turb} = 4.528 \times {10}^{4} watt$$

$$Compressor power required ; {Power}_{com} = 4.417 \times {10}^{4} watt$$

$$Engine efficiency ; \begin{matrix}{E}_{oall} := \frac{( {Power}_{out} - {Power}_{ram} - {Power}_{vanes} )}{{Heat}_{in}} \\ {E}_{oall} = 31.352 \%\end{matrix}$$

$$Shaft power output ; {Power}_{out} - {Power}_{ram} - {Power}_{vanes} = 1.563 \times {10}^{5} watt$$

$$Turbine \text{/} compressor power ratio ; \frac{{Power}_{turb}}{{Power}_{com}} = 1.025$$

1. An engine comprising:
a housing having at least one inlet and at least one outlet;
a compression fan adapted to rotate in a first sense to cause compression of at least one of at least one oxidising fluid and a mixture of at least one oxidising fluid and at least one fuel; and
a reaction member mounted substantially coaxially with said compression fan and comprising a single combustion zone, wherein the reaction member is adapted to receive the or each compressed oxidising fluid or mixture from said compression fan and the or each mixture or the or each oxidising fluid mixed with at least one fuel is burnt within said combustion zone and gases produced by said burning are directed to cause said reaction member to rotate in a second sense opposite to said first sense.

2. An engine according to claim 1, wherein said reaction member further comprises a plurality of nozzles which direct the gases produced by said burning so as to cause said reaction member to rotate.

3. An engine according to claim 2, wherein said reaction member comprises a pair of side walls having a substantially saw toothed outer edge in which first sections of said edges are connected together and second sections of said edges form said nozzles.

4. An engine according to claim 3, wherein said nozzles are formed by attaching nozzle shapers to said second sections of said edges.

5. An engine according to claim 1, further comprising at least one flame control device for controlling the location of the flame formed from combustion of the or each fuel within said reaction member.

6. An engine according to claim 5, wherein said at least one flame control device comprises at least one flame grid.

7. An engine according to claim 1, further comprising at least one mixing device for mixing the or each fuel with the or each oxidising fluid prior to combustion.

8. An engine according to claim 7, wherein said mixing device mixes the or each fuel with the or each oxidising fluid prior to it entering the compression fan.

9. An engine according to claim 1, further comprising at least one heat exchanging device for extracting heat from the gases formed from the combustion.

10. An engine comprising:
a housing having at least one inlet and at least one exhaust outlet;
a compression fan adapted to rotate in a first sense to cause compression of a fuel and air mixture; and
a reaction member mounted substantially coaxially with said compression fan and comprising a plurality of vanes, wherein the reaction member is adapted to receive said compressed fuel and air mixture from said compression fan and in use said fuel and air mixture is burnt between said vanes and gases produced by said burning are vectored to cause said reaction member to rotate in a second sense opposite to said first sense.

11. An engine according to claim 10, wherein said fuel and air mixture are further compressed within said reaction member.

12. An engine according to claim 11, wherein said further compression occurs by ram compression of said mixture within said reaction member.

13. An engine according to claim 11, wherein said further compression occurs by diffusion of said mixture within said reaction member.

14. An engine according to claim 13, wherein said further compression occurs by ram compression of said mixture within said reaction member.

15. An engine according to claim 10, wherein said compression fan discharges said mixture in a direction substantially tangential to a circle defined by the rotation of vane tips of the vanes of the compression fan.

16. An engine according to claim 10, wherein said fuel and air mixture is received within said reaction member at a velocity relative to the reaction member substantially equal to the sum of the velocities of the compression fan vane tips and the reaction member at substantially the same radius.

17. An engine according to claim 10, further comprising at least one turbine member for driving said compression fan.

18. An engine according to claim 17, wherein at least one said turbine member is driven by exhaust gases from said reaction member.

19. An engine according to claim 10, wherein said fuel and air mixture is mixed prior to entry into the engine through each inlet.

20. An engine according to claim 10, wherein a cross-sectional area, measured in a circumferential direction, of the space defined by two adjacent vanes, increases as the radial distance from the axis of the reaction member increases, to a maximum substantially half way along the length of said vanes, and then decreases as said radial distance further increases.

21. An engine according to claim 10, wherein said reaction member further comprises a flame grid.

22. An engine according to claim 21, wherein the flame grid is located at a position along the vanes where the cross-sectional area defined by adjacent vanes is at its greatest.

23. An engine according to claim 10, wherein said vanes are adapted to reduce a cross-sectional area, measured in a circumferential direction, of the space defined by two adjacent vanes, decreases as the radial distance from the axis of the reaction member increases, to a minimum cross-sectional area, thereby substantially defining the flame front, before increasing.

24. An engine according to claim 10, wherein the reaction member further comprises at least one outer supporting member which supports said vanes along at least some of their length.

25. An engine according to claim 24, wherein said vanes are supported substantially along their whole length.

26. An engine according to claim 24, comprising two said outer supporting members attached to said vanes along opposing edges of said vanes.

27. An engine according to claim 26, wherein said vanes are supported substantially along their whole length.

28. An engine according to claim 10, wherein said outer supporting members extend to at least partially cover the compression fan.

29. An engine according to claim 10, wherein said vanes at their smallest radial distance from the axis of the reaction member are at an angle substantially tangential to the outer radius of the compression fan.

30. An engine according to claim 10, wherein said housing has at least one further inlet, adapted to allow a flow of cooling air to be entrained between said housing and said reaction member.

31. An engine according to claim 30, wherein said reaction member has further vanes extending outside of the supporting members of the reaction member, and adapted to provide the flow of cooling air.

32. An engine according to claim 31, wherein said further vanes are adapted to provide said flow of air at a pressure substantially equivalent to a pressure of combustion products of the burning of the fuel and air mixture immediately adjacent a maximum radius of said reaction member
